(19) United States
(12) Patent Application Publication
(10) Pub. No.: US 2013/0032264 A1
(43) Pub. Date: Feb. 7, 2013

(54) OPEN OFF-THE-ROAD CORD WITH PREFORMED FILAMENTS

(71) Applicants: Zhichao Cheng, Jiangyin (CN); Pengfei Wang, Jiangyin (CN); Zhongwei Huang, Jiangyin (CN); Xiaodao Sheng, Jiangyin (CN)

(72) Inventors: Zhichao Cheng, Jiangyin (CN); Pengfei Wang, Jiangyin (CN); Zhongwei Huang, Jiangyin (CN); Xiaodao Sheng, Jiangyin (CN)

(21) Appl. No.: 13/636,035

(22) PCT Filed: Feb. 24, 2011
(86) PCT No.: PCT/EP11/52740

§ 371 Date: Sep. 19, 2012

(51) Int. Cl. D07B 1/06; B60C 9/00; B32B 15/02

(52) U.S. Cl. 152/451; 428/377

(57) ABSTRACT

A steel cord (10) for reinforcing rubber product comprises at least one core strand (12) and outer strands (14), the outer strands (14) are helically twisted around at least one core strand (12). Each of the strands (12, 14) comprises core steel filaments (16, 20) with the number of m and outer steel filaments with the number of n. The diameter of the core steel filaments in the core strand is Dcc, the diameter of the outer steel filaments in the core strand is Doc, the diameter of the core steel filament in the outer strand is Dco, and the diameter of the outer steel filament in the outer strand is Doo. The ratio of Dcc/Doc is not less than 1.04, the ratio of Dco/Doo is not less than 1.03, and the ratio of Doc/Dco is not less than 1. The core steel filaments and outer steel filaments are polygonally preformed before being twisted into strands. The steel cord is used for reinforcing off-the-road tire.

### TECHNICAL FIELD

The present invention relates to a steel cord for reinforcing rubber product. It also relates to an off-the-road tire reinforced by the steel cord.

### BACKGROUND ART

The off-the-road tire (OTR tire) includes tires for construction vehicles such as wheel loadersbackhoes, graders, trenchers, and the like; as well as large mining trucks. This type of tire is always used as a heavy load bearing tire. The steel cord reinforcing the OTR tire comprises a plurality of steel strands. Mostly the steel cord has multi strands with a structure of m+n. The structure ‘m+n’ means that the strand has m core filaments and n outer filaments twisting around the core filaments. The steel cord used to reinforce OTR tire is always required to have high strength to bear heavy load.

Generally the OTR tire is big and heavy for its particular using. Thus the steel cord must be thick and heavy to have enough strength to reinforce such OTR tire. But it will bring another problem: high cost of fuel. Light OTR tire is quite desired to the customer. Generally there are two ways to decrease the weight of the tire, one is decreasing the weight of the steel cord, and the other is decreasing the weight of the rubber material. Till now, it is a hard problem to get a lighter OTR tire without decreasing its strength.

On the other hand, the rubber penetration of the steel cord (OTR cord) which is used to reinforce the OTR tire is particularly required. For its high price, OTR cord is required to have long useful time to the customer to reduce the cost. Generally rubber penetration is the most important factor while evaluating the quality of the steel cord. If the rubber penetration is good, the friction between the filaments is low, and the wear of the filaments is low, then the fatigue resistance of the steel cord is good, then the useful time of the OTR cord is long. But due to the multi strands structure, the OTR cord always could not get high rubber penetration. To a general OTR cord, the filaments contact with each other to make a compact structure, so there are no enough gaps or space between the filaments to let the rubber penetrating in. It is very hard for the rubber to penetrate into the centre of the OTR steel cord.

EP 2065511A discloses a steel cord including a plurality of strands twisted together in the same direction with same pitch. It has a central structure and at least one outer layer. The central structure has at least two strands, and each of the strands has at least seven filaments. To get a good fatigue resistance, the steel cord is made compactly. As the filaments contact with each other, there is no space to let rubber penetrating in. The rubber penetration of such steel cord is not good enough to make sure its long useful time.

WO 95/16816 discloses a preformation on the filament. The filament is polygonally preformed to get different curve with different curvature radius perpendicular to the longitudinal axis along the length of the filament. The patent disclosure does not give a detailed description on how to use the polygonally preformed steel filament in OTR cord. Due to the polygonal preforming, the strength of the filament decreases after preforming. Viewed from this aspect, such preformed filament is not very suitable for reinforcing OTR tire.

### DISCLOSURE OF INVENTION

It is an object of the present invention to overcome the problem of the prior art.

It is another object of the present invention to provide a steel cord with high rubber penetration and light weight.

It is a further object of the present invention to provide an off-the-road tire reinforced by the steel cord.

According to the present invention, a steel cord for reinforcing rubber product comprises core strands and outer strands, the outer strands are helically twisted around the core strands. Each of the strands including core strands and outer strands comprises core steel filaments with the number of m and outer steel filaments with the number of n. The carbon content of the steel filament being not less than 0.7%. The outer steel filaments are helically twisted around the core steel filaments. The diameter of the core steel filament in the core strand is Dcc, the diameter of the outer steel filament in the core strand is Doc, the diameter of the core steel filament in the outer strand is Dco, and the diameter of the outer steel filament in the outer strand is Doo. The ratio of Dcc/Doc is not less than 1.04, the ratio of Dco/Doo is not less than 1.03, and the ratio of Doc/Dco is not less than 1. The core steel filaments and outer steel filaments are polygonally preformed before being twisted into strands.

To get a good rubber penetration, the steel filaments which are close to the centre of the steel cord have the bigger diameter, and the steel filaments which are far away from the centre of the steel cord have the smaller diameter. Preferably Dcc>Doc≧Dco>Doo. As the core steel filaments in the core strand have the bigger diameter, the outer steel filaments in the core strand can not cover all the surface of the core steel filaments in the core strand. So there will be a number of gaps or space between the steel filaments in the core strand. Meanwhile, to the outer strand, the core steel filaments has the bigger diameter than the outer steel filament in the outer strand, thus the outer steel filaments can not cover all the surface of the core steel filaments. There also will be a lot of gaps or space between the steel filaments in the outer strands. The rubber can penetrate into each steel strand while the process of vulcanization. The useful time of the rubber product reinforced by such steel cord increases a lot.

Preferably the ratio of Dcc/Doc is not less than 1.06. The bigger the ratio of Dcc/Doc, the better rubber penetration. More preferably the ratio of Dcc/Doc ranges from 1.06 to 1.14.

Preferably the ratio of Dco/Doo is not less than 1.07. The bigger the ratio of Dco/Doo, the better rubber penetration. More preferably the ratio of Dco/Doo ranges from 1.07 to 1.15.

The ratio of Doc/Dco is not less than 1. It means that the diameter of the outer filament of the core strand is not less than the diameter of the core filament of the outer strand. Thus the diameter of the core strand is bigger than the diameter of the outer strand. In the same way, there will be enough gaps or space between the core strands and the outer strands to insure the rubber penetration between the strands.

All the steel filaments in the strands are polygonally preformed before being twisted into the steel cord. As a result, the steel cord is not a compact cord. The gaps between the filaments are enough. The steel cord has excellent rubber penetration property.

WO 95/16816 discloses the polygonally preformed steel filament. Polygonal preforming is a preformation which gives the steel filament projections on a plane perpendicular to the longitudinal central axis. The projections are in the form of curves which are convex curves with a radius of curvature alternating between a maximum and a minimum. The radius of the curvature of the preformed steel filament alternates between two extremes: a minimum at the point where the highest bending has been given and a maximum at the point where the smallest bending has been given. As a consequence of the rotating of the filament around its own longitudinal axis, the radius of curvature of the steel filament always points in the direction of a central axis of the steel wire. It means that the polygon has a convex form. In other words, the zone of plastical tension of the steel filament always lies radially outward while the zone of plastical compression lies radially inward.

With the decrease of radius of curvature, the loss of the strength of the steel filament is increasing, but rubber penetration of steel cord comprising such steel filaments is also increasing for the gaps between the filaments are enlarging. To the polygonally preformed steel filament, the radius of curvature is determined by the requirement of properties of final product.

However, different from theory, the steel filaments with the polygonally preforming will take a good advantage to the final steel cord. The rubber penetration of the steel cord will improve a lot while without decreasing the strength a lot.

Normally, to the strand, the diameter of the core filament is bigger than the diameter of the outer filament, the gaps between the outer filaments will enlarge with the balance of the diameter of the core filament and the outer filament. The bigger the diameter balance, the bigger the gap.

Compared with the strand comprising normal filaments without any preformation, the strand will have larger gaps while comprising polygonally preformed steel filaments with the same diameter as normal filaments.

Thus, for one thing, to keep same gaps as usual and without changing the diameter of the outer filaments, the diameter balance can be smaller than usual. It means that the diameter of core filaments can be smaller while using the polygonally preformed wires forming the strand. Finally the diameter of the steel cord will be smaller. For the smaller diameter, steel cord will be lighter. The tire also will be lighter. The cost of fuel will be smaller.

For another, to get the same gaps as usual and without changing the diameter of the core filaments, the diameter of the outer filaments with polygonal preformation can be smaller than normal filaments. Then the weight of the steel cord will be smaller. The tire also will be lighter. The cost of fuel will be smaller.

Further, to keep same diameter of the core steel filaments and outer steel filaments as usual, the gaps will enlarge while using the polygonally preformed steel filaments. The rubber will penetrate into the steel cord easily. The wear between the filaments will decrease. The life time of the steel cord will increase.

In one word, the polygonally preformed steel filaments take two advantages to the final steel cord, one is smaller diameter, and the other is better rubber penetration.

The polygonally preformed steel filaments are helically twisted before they are twisted into the strands. The twisting direction of the strand is the same as the twisting direction of the steel filaments. All the strands have the same twisting direction. Then the strands including the core strands and outer strands are twisted into steel cord. The twisting direction of the steel cord can be the same or different from the twisting direction of the strands. For example, the twisting direction can be S/S/S/S/S or S/S/S/S/Z.

As a result, the outer filaments are helically twisted around the core filaments, and the outer strands are helically twisted around the core strands.

Preferably, the twisting direction of the steel cord is different from the twisting direction of the strand, i.e. S/S/S/S/Z. As a result, the stiffness of the steel cord will be better than the steel cord which has the same twisting direction as the strand. In the same way, the fatigue resistance of the steel cord will be better.

For reinforcing OTR tire, the steel cord comprises multi strands including core strands and outer strands to make its strength big enough. It is a common way to improve the strength of the steel cord by increasing the number of the strands and the number of the steel filaments.

Preferably, the number of the core strand ranges from 1 to 2. More preferably, the number of the core strand is 1.

Preferably, the number of the outer strand ranges from 5 to 9. More preferably, the number of the outer strand is 6.

To the present invention, each of the strands comprises core steel filaments with the number of m and outer steel filaments with the number of n.

Preferably m ranges from 2 to 4. More preferably m is 3.

Preferably n ranges from 6 to 12. More preferably n is 9.

Most preferably n is between m+4 to m+10.

The preferably steel cord has the structure of 1×(3+9)+6×(3+9), 2×(2+8)+8×(2+8), 1×(2+9)+7×(2+9), or 1×(2+8)+6×(2+8), 2×(3+8)+7×(3+8), 2×(3+9)+7×(3+9), 2×(2+8)+6×(2+8), 2×(3+9)+8×(3+9).

To get high tensile strength of the steel cord, the tensile strength TS of steel filament satisfies: TS≧3800-2000D, wherein D is the diameter of said steel filament in mm. Preferably TS≧4000-2000D.

There can be a wrap filament twisted around the steel cord or not. Preferably there is no wrap filament. As without wrap filament, the diameter of the steel cord will be smaller than the steel cord with wrap filament. The weight of the steel cord will be smaller. The cost of fuel will be reduced.

According to the present invention, the steel cord has very good rubber penetration, small diameter and good fatigue resistance while without decreasing its strength a lot. Furthermore it presents good fuel cost saving while the steel cord is used for reinforcing rubber tire. The steel cord is used for reinforcing rubber product, such as conveyor belt, rubber tire, and rubber track. Preferably the steel cord is used for reinforcing off-the-road tire.

### BRIEF DESCRIPTION OF FIGURES IN THE DRAWINGS

FIG. 1 shows a sectional view of the invention steel cord with a structure of 1×(3+9)+6×(3+9)

FIG. 2 shows a sectional view of the prior art steel cord with a structure of 1×(3+9)+6×(3+9)

FIG. 3 shows a sectional view of the prior art steel cord with a structure of 1×(3+9)+6×(3+9)+1

FIG. 4 shows a side view of steel filament with polygonal preforming

FIG. 5 shows a sectional view of steel filament with polygonal performing

FIG. 6 shows the fatigue comparison between the invention steel cord and prior art steel cord

FIG. 7 shows a sectional view of the invention steel cord with a structure of 1×(3+9)+6×(3+9)+1

FIG. 8 shows a sectional view of the invention steel cord with a structure of 1×(2+8)+6×(2+8)

### MODE(S) FOR CARRYING OUT THE INVENTION

A polygonally preformed steel filament can be made as follows:

The wire rod composition has a minimum carbon content of 0.70%, a maximum carbon content of about 1.10%, a manganese content ranging from 0.40% to 0.70%, a silicon content ranging from 0.15% to 0.30%, a maximum sulphur content of 0.03%, a maximum phosphorus content of 0.30%, all percentages being percentages by weight. Usually there are only traces of copper, nickel, luminium, titanium, and nitrogen and/or chromium, except for very high tensile strengths.

The wire rod is firstly cleaned by mechanical descaling and/or by chemical pickling in a H₂SO₄ or HCl solution in order to remove the oxides present on the surface. The wire rod is then rinsed in water and is dried. The dried wire rod is then subjected to a first series of dry drawing operations in order to reduce the diameter until a first intermediate diameter.

At this first intermediate diameter, e.g. at about 3.0 to 3.5 mm, the dry drawn steel filament is subjected to a first intermediate heat treatment, called patenting. The steel filament is then ready for further mechanical deformation.

Thereafter the steel filament is further dry drawn from the first intermediate diameter until a second intermediate diameter in a second number of diameter reduction steps. The second diameter typically ranges from 1.0 mm to 2.5 mm.

At this second intermediate diameter, the steel filament is subjected to a second patenting treatment to allow for transformation to pearlite.

After this second patenting treatment the steel filament is provided with a brass coating: copper is plated on the steel filament and zinc is plated on the copper. A thermo-diffusion treatment is applied to form the brass coating.

Additionally the steel filament may be provided with an organo functional silane coating upon the brass coating.

Then steel filament is subjected to a final series of cross-section reductions by means of wet drawing machines. The final product is a round steel filament with a carbon content above 0.60 percent by weight, with a tensile strength typically above 3800-2000D Mpa and adapted for the reinforcement of rubber products.

The round steel filaments adapted for reinforcing tyre typically have a final diameter ranging from 0.10 mm to 0.60 mm, e.g. from 0.20 mm to 0.40 mm. Examples of filament diameters are 0.20 mm, 0.22 mm, 0.245 mm, 0.28 mm, 0.30 mm, 0.32 mm, 0.35 mm, 0.38 mm, 0.40 mm.

Then the round steel filament passes over the deforming device to get the polygonal preformation. WO 95/16816 discloses the detailed description on the process of manufacturing such preformation. Thus a polygonally preformed steel filament is produced.

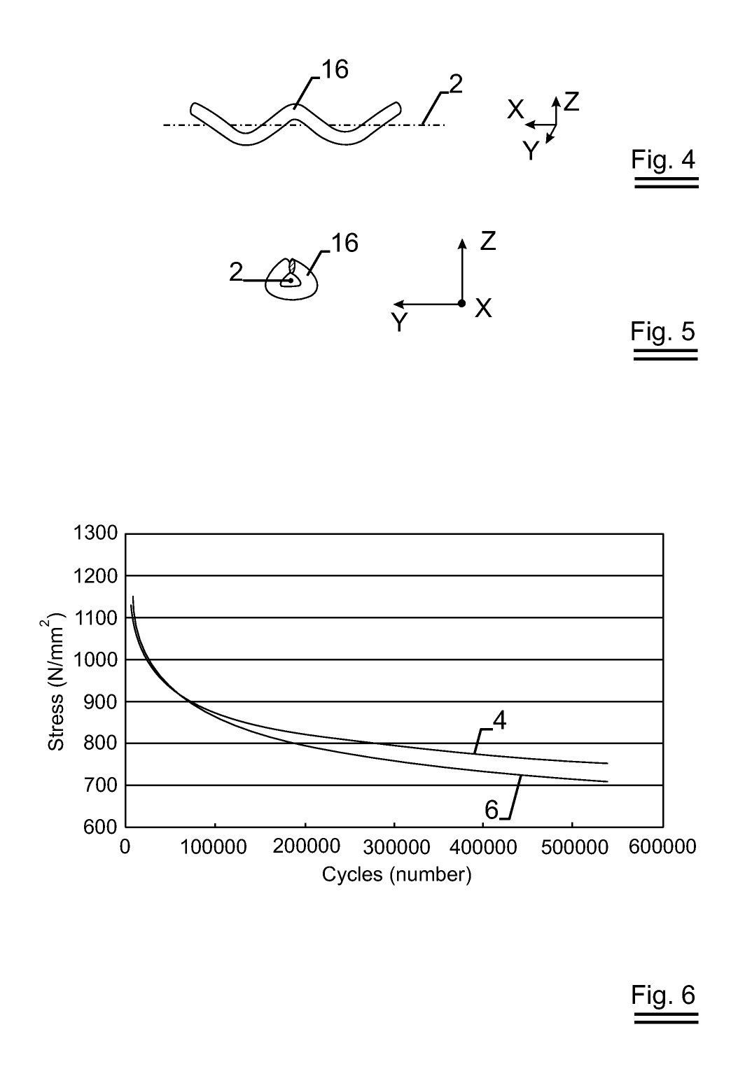

A polygonally preformed steel filament 16 is shown in FIG. 4 and FIG. 5. FIG. 4 shows the side view of steel filament 16. There is a longitudinal and central axis 2 along the length of the steel filament 16. The X-axis is parallel to the axis 2, while the Y-axis and the Z-axis lie in a plane perpendicularly to the axis 2. FIG. 5 shows the sectional view of steel filament 16. The polygonal preforming takes in the form of curves with rounded edges rather than the usual circular form, and the scales in Y- and Z-direction are much larger than the scale in X-direction. The radius of the curvature of the preformed steel filament alternates between two extremes: a minimum at the point where the highest bending has been given and a maximum at the point where the smallest bending has been given.

Then core filaments which have been twisted together already and outer filaments are guided into a double twisting machine or buncher which has two flyers. The core steel filaments are guided from the spool and are travelling along the first flyer where they receive two times a twist in a first direction (e.g. S-direction). The outer steel filaments are unwound from their spools and are guided around the core steel filaments. The core steel filaments with the outer steel filaments are then travelling along the second flyer where they all receive two times a twist in a second direction same as the first direction (e.g. S-direction). It's the same way to make core and outer strands consisting of filaments with different diameters.

Then the core strands and outer strands are twisted into steel cord by cabling. The core strands remain the twisting direction (e.g. S-direction) and the outer strands remain the twisting direction or not (e.g. S-direction or Z-direction).

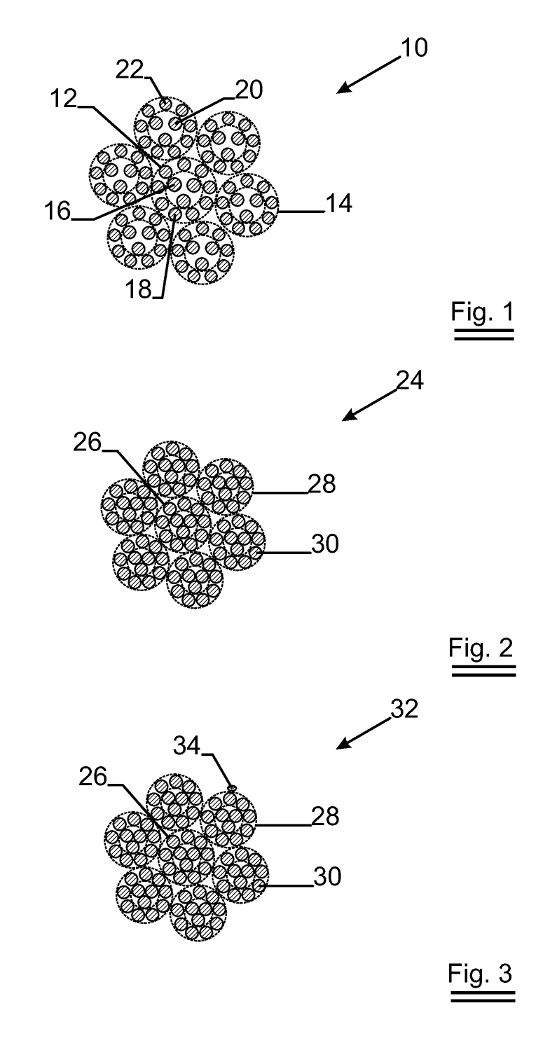

A first preferred embodiment is shown in FIG. 1. The steel cord 10 has a structure of 1×(3+9)+6×(3+9). The steel cord 10 is consisted of one core strand 12 and six outer strands 14. The core strand 12 is consisted of three core steel filaments 16 and nine outer steel filaments 18. Each outer strand 14 is consisted of three core steel filaments 20 and nine outer steel filaments 22. The diameter of the steel filament 16 Dcc₁₀ is 0.32 mm. The diameter of the steel filament 18 Doc₁₀ is 0.30 mm. The diameter of the steel filament 20 Dco₁₀ is 0.30 mm. The diameter of the steel filament 22 Doo₁₀ is 0.28 mm. The steel 16, 18, 20 and 22 are polygonally preformed before being twisted into the strand. The twisting direction is S/S/S/S/Z.

A compared prior art steel cord is shown in FIG. 2. The steel cord 24 has a structure of 1×(3+9)+6×(3+9). The steel cord 24 is consisted of one core strand 26 and six outer strands 28. Each strand is consisted of three core steel filaments 30 and nine outer steel filaments 30. The diameter of steel filament 30 is 0.30 mm. The steel filament 30 has no preformation before being twisted into the strand. The twisting direction is S/S/S/S/Z.

A compared prior art steel cord is shown in FIG. 3. The steel cord 32 has a structure of 1×(3+9)+6×(3+9)+1. The steel cord 32 is consisted of one core strand 26, six outer strands 28 and one wrap filament 34. Each strand is consisted of three core steel filaments 30 and nine outer steel filaments 30. The diameter of steel filament 30 is 0.30 mm. The wrap filament 34 has the diameter of 0.20 mm. The steel filaments 26 and 34 have no preformation before being twisted into the strand. The twisting direction is S/S/S/S/Z.

Rubber penetration is the important property of the rubber product which is embedded with the steel cord. To the present invention, the rubber penetration is measured by air permeability method on the rubber ply embedded with the steel cord.

One test between the invention steel cord 10 and compared prior art steel cord 28 is carried out. The following Table 1 summarizes the test result.

TABLE 1

| | steel cord 10 | prior art steel cord 24 |
|---|---|---|
| Cord | 3.58 | 3.82 |
| diameter (mm) | | |
| Rubber | 100 | 30 |
| penetration (%) | | |

The above Table 1 shows that the cord diameter of invention steel cord 10 is smaller than the prior art. Thus the rubber bridge which means that the distance between two steel cords is smaller. With the decrease of the rubber bridge, the weight of the rubber material decreases a lot. The weight of the rubber tire decreases while without decrease the weight of the steel cord a lot. Additionally the rubber penetration of the present invention is much better than the prior art.

Another test between the invention steel cord 10 and compared prior art steel cord 32 is carried out. The following Table 2 summarizes the test result.

TABLE 2

| | steel cord 10 | prior art steel cord 32 |
|---|---|---|
| Cord diameter (mm) | 3.58 | 4.11 |
| Breaking Load (N) | 14000 | 15000 |
| Ply weight (%) | 95 | 100 |
| Rubber penetration (%) | 100 | 25 |

The above Table 2 shows that the cord diameter of invention steel cord 10 is smaller than the prior art while without decreasing the breaking load a lot. The weight of the rubber ply embedded with the invention steel cord is smaller than prior art. The rubber penetration is much better than the prior art.

Both the two tests present that the present invention improve the rubber penetration property of the steel cord. The weight of the rubber product is also decreasing, and it will save a lot of cost for the customer, such as rubber material and even fuel.

A further test is the fatigue resistance comparison between the invention steel cord 10 and prior art steel cord 32. FIG. 6 shows the comparison result. Curve 4 shows the fatigue property of invention steel cord 10 and curve 6 shows the fatigue property of prior art steel cord 32. From FIG. 6, it is obviously that the fatigue of the invention steel cord is much better than the prior steel cord.

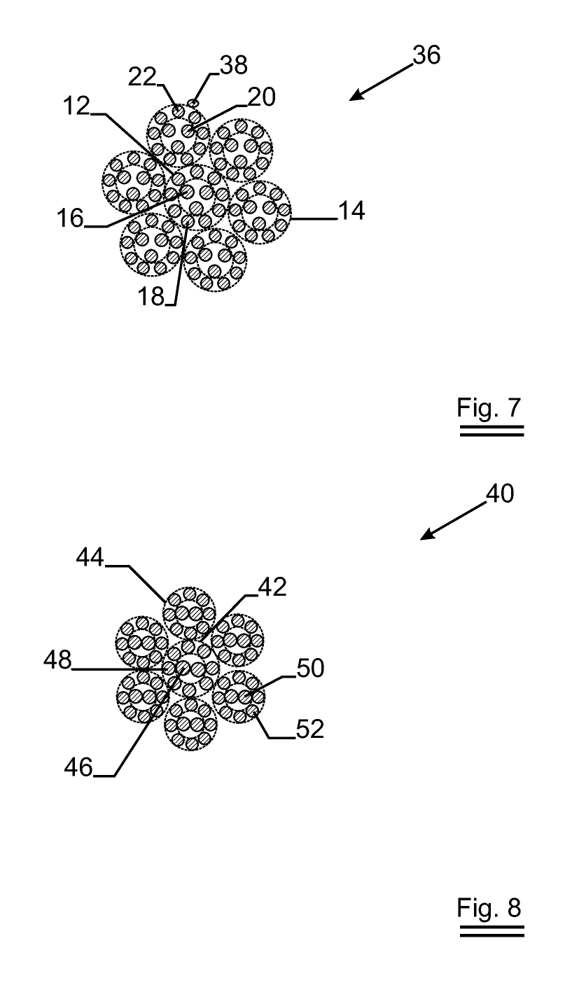

A second preferred embodiment is shown in FIG. 7. The steel cord 36 has a structure of 1×(3+9)+6×(3+9)+1. The steel cord 36 is consisted of one core strand 12, six outer strands 14 and one wrap filament 38. The core strand 12 is consisted of three core steel filaments 16 and nine outer steel filaments 18. Each outer strand 14 is consisted of three core steel filaments 20 and nine outer steel filaments 22. The diameter of the steel filament 16 Dcc₃₆ is 0.32 mm. The diameter of the steel filament 18 Doc₃₆ is 0.30 mm. The diameter of the steel filament 20 Dco₃₆ is 0.30 mm. The diameter of the steel filament 22 Doo₃₆ is 0.28 mm. The diameter of the wrap filament 38 is 0.20 mm. The steel filaments 16, 18, 20 and 22 are polygonally preformed before being twisted into the strand. The twisting direction is S/S/S/S/Z.

A third preferred embodiment is shown in FIG. 8. The steel cord 40 has a structure of 1×(2+8)+6×(2+8). The steel cord 40 is consisted of one core strand 42 and six outer strands 44. The core strand 42 is consisted of two core steel filaments 46 and eight outer steel filaments 48. Each outer strand 44 is consisted of two core steel filaments 50 and eight outer steel filaments 52. The diameter of the steel filament 46 Dcc₄₀ is 0.34 mm. The diameter of the steel filament 48 Doc₄₀ is 0.31 mm. The diameter of the steel filament 50 Dco₄₀ is 0.30 mm. The diameter of the steel filament 52 Doo₄₀ is 0.27 mm. The steel filaments 46, 48, 50 and 52 are polygonally preformed before being twisted into the strand. The twisting direction is S/S/S/S/S.

A forth preferred embodiment is a steel cord has a structure of 1×(3+8)+7×(3+8). The diameter of the core steel filament in the core strand is 0.33 mm. The diameter of the outer steel filament in the core strand is 0.31 mm. The diameter of the core steel filament in the outer strand is 0.31 mm. The diameter of the outer steel filament in the outer strand is 0.27 mm. The diameter of the wrap filament is 0.18 mm. All the steel filaments are polygonally preformed before being twisted into the strands. The twisting direction is S/S/S/S/S.

1. A steel cord for reinforcing rubber products comprising core strands and outer strands, said outer strands being helically twisted around said core strands,
each of said strands comprising core steel filaments with the number of m and outer steel filaments with the number of n, the carbon content of said steel filaments being not less than 0.7%, said outer steel filaments being helically twisted around said core steel filaments,
the diameter of said core steel filament in said core strand being Dec, the diameter of said outer steel filament in said core strand being Doc, the diameter of said core steel filament in said outer strand being Dco, the diameter of said outer steel filament in said outer strand being Doo,
characterized in that the ratio of said Dec/Doc is not less than 1.04, the ratio of said Dco/Doo is not less than 1.03, the ratio of said Doc/Dco is not less than 1, said core steel filaments and outer steel filaments are polygonally preformed before being twisted into strands.

2. A steel cord for reinforcing rubber product as claimed in claim 1, characterized in that said ratio of said Dcc/Doc is between 1.06 and 1.14.

3. A steel cord for reinforcing rubber product as claimed in claim 1, characterized in that said ratio of said Dco/Doo is between 1.07 and 1.15.

4. A steel cord for reinforcing rubber product as claimed in claim 1, characterized in that said m ranges from 2 to 4.

5. A steel cord for reinforcing rubber product as claimed in claim 4, characterized in that said m is 3.

6. A steel cord for reinforcing rubber product as claimed in claim 1, characterized in that said n ranges from 6 to 12.

7. A steel cord for reinforcing rubber product as claimed in claim 6, characterized in that said n is 9.

8. A steel cord for reinforcing rubber product as claimed in claim 1, characterized in that the number of said core strand ranges from 1 to 2.

9. A steel cord for reinforcing rubber product as claimed in claim 8, characterized in that said number of said core strand is 1.

10. A steel cord for reinforcing rubber product as claimed in claim 1, characterized in that said number of said outer strand ranges from 5 to 9.

11. A steel cord for reinforcing rubber product as claimed in claim 10, characterized in that said number of said outer strand is 6.

12. A steel cord for reinforcing rubber product as claimed in claim 1, characterized in that the tensile strength TS of said steel filament satisfies: TS≧3800-2000D, while said D is the diameter of said steel filament in mm.

13. A steel cord for reinforcing rubber product as claimed in claim 1, characterized in that the twisting direction of said steel cord is different from the twisting direction of said strand.

14. A steel cord for reinforcing rubber product as claimed in claim 1, characterized in that the twisting direction of said strand is the same as the twisting direction of said steel filament.

15. Use of a steel cord according to claim 1 for reinforcing an off-the-road tire.
